(19) United States
(12) Patent Application Publication
(10) Pub. No.: US 2011/0135069 A1
(43) Pub. Date: Jun. 9, 2011

(54) PHONE CONVERSATION RECORDING SYSTEM USING CALL CONTROL AND FUNCTIONS OF PHONE CONVERSATION RECORDING

(75) Inventor: KAZUKI YOSHIDA, Kawasaki (JP)

(73) Assignee: Hitachi, Ltd.

(21) Appl. No.: 12/844,547

(22) Filed: Jul. 27, 2010

(30) Foreign Application Priority Data
Dec. 3, 2009 (JP) 2009-275057

(51) Int. Cl. H04M 1/64; G10L 17/00

(52) U.S. Cl. 379/85; 704/246; 704/E17.001

(57) ABSTRACT

New functions are added to the existing telephone network to provide services of a telecommunications carrier which are intended to deter frauds and crimes committed using telephony. Also, the telephonic circumstances during the commitment of a fraud or crime are preserved to assist prevention of recommitment of a fraud or crime. A voice announcement indicating that a telephone conversation now started will be recorded is issued to a sender in advance. This offers a function that deters frauds and crimes by creating psychological resistance. A warning is issued to the recipient after performing a voiceprint check. The contents of telephone conversations during the commitment of a fraud or crime are played back to provide information necessary to take countermeasures against frauds and crimes.

### INCORPORATION BY REFERENCE

The present application claims priority from Japanese Patent Application JP2009-275057 filed on Dec. 3, 2009, the content of which is hereby incorporated by reference into this application.

### BACKGROUND OF THE INVENTION

The present invention relates to a system for deterring criminal acts performed via telephones (such as frauds), as well as for preventing recommitment of such criminal acts.

As the network technology has improved, it has become possible to communicate both speech and non-speech information over the same network at the same time. Thus, merging of telephone networks and information communication networks has been realized. Furthermore, information about calls necessary for communications can be controlled on a network, as well as speech information. Communication control can be utilized easily and in various formats by interposing servers that provide communication services.

However, with the development of the above-described telephone conversation technology on networks, there occur more and more nuisance calls and other problems such as frauds. Therefore, it has become important to take countermeasures against such nuisance calls.

For example, JP-A-2007-159043 discloses a structure using an anti-nuisance call device which is inserted in the line when a call has arrived at the terminal device of a called party. If the anti-nuisance call device has determined that there is a nuisance call, a supporting person comes into assistance with the terminal device. Prior art references pertinent to the technique of the present invention include RFC2543, RFC2976, and RFC3261.

With the above-described techniques, it is possible to assist the called party afterward. However, it is impossible to suppress the generation of criminal actions themselves.

The problems with conventional, general telephone services are described in detail. One example of system configuration of the prior art telephone services is shown in FIG. 19, where if a call is made from a phone terminal 1901 of an originator toward a phone terminal 1902 of a recipient, a telephone connection is established via a network 1903. A SIP server 1904, an IVR server 1905 and a phone conversation recording server 1906 rarely function unless the destination is a communicating party that assumes some form of service provision or another such as the telecommunications carrier itself or an enterprise's call center.

Where conversations between individuals are made, the IVR server 1905 or phone conversation recording server 1906 can be activated but it is difficult to clarify its purpose and advantages. The IVR server 1905 or phone conversation recording server 1906 is merely a means. In order to accept the server as a service provider, it is necessary to operate the server while clarifying its purpose and advantages. In the existing circumstances, neither the IVR server 1905 nor the phone conversation recording server 1906 is accepted into general use as a useful service for person-to-person conversations.

Plural telecommunications carriers which provide conventional telephone functions offer various countermeasures and services against criminal acts such as nuisance calls. One of the typical countermeasures consists of storing the telephone number of a nuisance call once made and then automatically blocking the next incoming call. Another countermeasure is to reject any incoming call from an originator having a telephone number unknown to the recipient. A further countermeasure is to block any incoming call from a phone number not previously registered in the cell phone.

FIGS. 20A and 20B illustrate two examples of sequence of operations performed to carry out the prior art countermeasures against nuisance calls. The two examples are identical in that an incoming call rejection decision 2001 or 2003 and an incoming call rejection process 2002 or 2004 are performed.

They are identical in service contents although different in service mechanism. The mere difference is whether it is provided to the called party as a carrier's service or as one function of the phone terminal of the called party.

This service includes the incoming call rejection decision 2001 or 2003. In particular, incoming calls from the telephone number of an originator who is regarded as a source of criminal acts (i.e., the number is already known to be used for criminal offenses) are rejected (prevention of recommitment of criminal acts). Otherwise, any incoming call from a telephone number which is not informed to the recipient or which is unknown to the recipient is regarded as malicious and its arrival is rejected without checking whether or not the communicative intent of the originator is malicious (unconditional rejection of incoming calls).

In the incoming call rejection process 2002 or 2004, telephone communications with the recipient are not established by sending back a message indicating a busy state to the originator, issuing a voice announcement indicating that the incoming call cannot be accepted, or routing the incoming call to a telephone answering service.

Consequently, any countermeasure against a first criminal offense is not taken into consideration. Furthermore, there is the problem that if there is an incoming call from a telephone number unknown to the recipient but the call carries a non-malicious message, then the information that the recipient should accept cannot be obtained.

### SUMMARY OF THE INVENTION

The above-described problem can be solved by a phone conversation recording system for recording the contents of phone conversations between terminals in accordance with the present invention, the recording system having an incoming call connection server for controlling a call connection between the terminals, a voice message answering server for sending a voice message to the originator terminal, and a phone conversation recording server for recording the contents of the phone conversations between the conversationally communicating terminals. When a request for a call connection is received from the originator terminal, the call connection server routes the request to the voice message answering server, which in turn informs the originator terminal issuing the call connection request that the contents of phone conversations will be recorded. When phone conversations are performed between the originator terminal and the receiver terminal, the phone conversation recording server relays and records the contents of the conversations.

The present invention makes it possible to deter criminal acts and to preserve and refer to information capable of reproducing criminal circumstances, if a criminal act was done, by adding new functions to the existing system.

The other objects and methods of achieving the objects will be readily understood in conjunction with the description of embodiments of the present invention and the drawings.

### BRIEF DESCRIPTION OF THE DRAWINGS

FIG. 1 shows a block diagram of a whole system according to one embodiment of the present invention;

FIG. 2 shows a functional diagram of phone terminals and a network;

FIG. 3 shows a functional diagram of a handle server;

FIG. 4 shows a functional diagram of an SIP server;

FIG. 5 shows a functional diagram of an IVR server;

FIG. 6 shows a functional diagram of a phone conversation recording server;

FIG. 7 illustrates a subscriber information table in the handle server;

FIG. 8 illustrates a flowchart depicting a sequence of processing steps of a subscriber information registration routine;

FIG. 9 illustrates a sequence of processing steps of the subscriber information registration routine;

FIG. 10A illustrates the contents of a phone conversation recording table stored in the server;

FIG. 10B illustrates the contents of a registered voiceprint table stored in the server;

FIG. 11 illustrates a flowchart depicting a sequence of processing steps for a phone conversation recording routine;

FIG. 12 illustrates a flowchart depicting a sequence of processing steps of a voiceprint check routine;

FIG. 13 illustrates a sequence of processing steps of the phone conversation recording routine;

FIG. 14 illustrates a flowchart depicting a sequence of processing steps of a recorded phone conversation playback routine;

FIG. 15 illustrates a sequence of processing steps of the recorded phone conversation playback routine;

FIG. 16 illustrates a subscriber information table in an SIP server;

FIG. 17 illustrates a subscriber information table in a phone conversation recording server;

FIG. 18 illustrates a table depicting an example of a set of recording deletion criteria;

FIG. 19 shows a block diagram depicting one prior art system; and

FIGS. 20A and 20B illustrate two examples of sequence of operations for taking the prior art countermeasure against nuisance calls.

### DETAILED DESCRIPTION OF THE EMBODIMENTS

It can be expected that criminal acts will be deterred and that losses due to recommitment of criminal acts by the same fraudster will be suppressed by adopting the inventive configuration described herein.

The telecommunications carrier vocally informs the originator that the phone conversation will be recorded and then the incoming call is accepted. Thus, it is expressed clearly in advance that a vocal recording constituting a proof will be made. This urges a malicious originator to recognize a decrease in the anonymousness, making him wary of arrest and punishment. As a result, he would be compelled to be refrained from committing a criminal act. In this way, criminal acts would be deterred.

In order to suppress losses due to recommitment of crimes by the same fraudster or criminal, voiceprint data obtained from the newest speech recording is compared against voiceprint data extracted from speech recordings of past crimes. When a hit is obtained or the probability of coincidence is in excess of a given value, a warning is given to the recipient or system administrator. Thus, repeated criminal acts by the same fraudster can be deterred based on information obtained from past recordings.

Therefore, criminal circumstances are preserved as reproducible information to which reference can be made. This secures recording of criminal acts. Furthermore, information necessary in analyzing the modi operandi of crimes and groping for a countermeasure is made more objective than information derived from memory of defrauded persons. In addition, voiceprint data necessary to prevent recommitment of criminal acts as described later can be extracted.

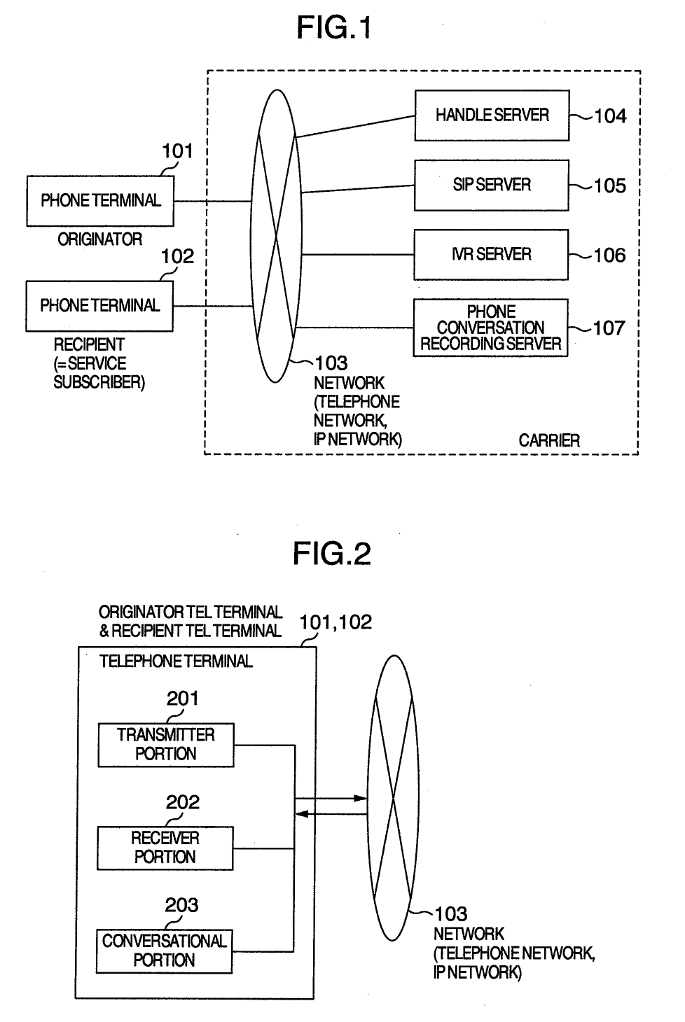

A mode of practice of the present invention is hereinafter described with reference to the drawings. The configuration of the whole system and each component or device are described. FIG. 1 shows the whole system configuration according to the invention. The system is an SIP (session initiation protocol)-based IP telephony service network. In the present embodiment, servers 104, 105, 106, and 107 are added to and coordinated with an existing network 103, thus affecting communications between a phone terminal 101 of an originator and a phone terminal 102 of a recipient.

The originator in FIG. 1 indicates any one of the general public who wants to establish a telephone conversation with the recipient. The recipient in FIG. 1 is a person who receives the services of the present invention. Incoming calls from an originator destined to a non-subscriber recipient are handled according to the existing telephone service procedures.

Existing devices or equipment may be intact used respectively as the phone terminal 101 used by the originator, the phone terminal 102 used by the recipient, and the network 103 via which phone conversations are communicated. The handle server 104 acts as a user interface when the subscriber receives the services of the present invention. The handle server 104 offers environments under which service settings are registered or updated to the subscriber, and acts also as a port through which the subscriber replays and listens to the contents of the recorded phone conversations. The handle server functions preserve and manage the contents of settings for each individual subscriber. When an addition or alteration to the settings is made, the handle server transmits the update information to the SIP server 105 and the phone conversation recording server 107.

When there is an incoming call on the subscriber, the SIP server 105 makes a decision as to whether operations for providing services should be performed. The SIP server 105 has the functions of the existing SIP server to which the functions of a decision and a judgment (i.e., a decision made as to whether the destination of the incoming call is a subscriber to the services of the present invention and a condition judgment previously set by the subscriber with the handle server using the telephone number of the originator) are added. If the result of the condition judgment is that the processing of services is made to progress, call control is transferred to the IVR server 106. If the result is that the services are not applied, the present server continues the normal telephonic services.

The IVR (interactive voice response) server 106 once receives the incoming call routed from the SIP server 105, issues to the originator a voice message that the contents of the phone conversation will be recorded, and then routes the call to the phone conversation recording server 107.

The phone conversation recording server 107 establishes the call received from the IVR server 106. That is, the server 107 causes the recipient to accept the call. The call connection is maintained until the call is disconnected, and the contents of the phone conversation are recorded. After the disconnection of the call, the recorded voice information is stored in the database of the server itself. The server 107 extracts voiceprint data about the originator and compares it against the voiceprint data about registered persons under surveillance. If a hit is obtained or the rate of coincidence is in excess of a given value, a warning is delivered to the system administrator and to the recipient.

In the embodiment of FIG. 1, there are mounted the individual servers 104-107. These servers do not need to be physically separate servers. Instead, they may be realized by their equivalent functions present on a network. Therefore, some of the functions of the individual servers 104-107 may be realized by a physically single server.

The components of the above-described system are next described. FIG. 2 shows the structures of the phone terminals of the originator and of the recipient, as well as the network. The phone terminal 101 of the originator and the phone terminal 102 of the recipient are identical in functions associated with the present invention.

The function used by the sender for transmission to ask the recipient to receive an incoming call when a phone conversation is performed via the network 103 is defined as a transmitter portion 201. The function used to inform the recipient that the phone terminal is receiving the request for acceptance of the incoming call is defined as a receiver portion 202. The function which is used by the recipient to perform a phone conversation with an originator after recognizing the request for acceptance of the incoming call and which is employed to establish and maintain the call until the end of the conversation and to control the disconnection of the call is defined as a conversational portion 203. The functions illustrated in FIG. 2 are realized by existing techniques. The network 103 is the whole equipment realized by the existing techniques and includes a function of controlling the call between the phone terminal of the sender and the phone terminal of the recipient within the network.

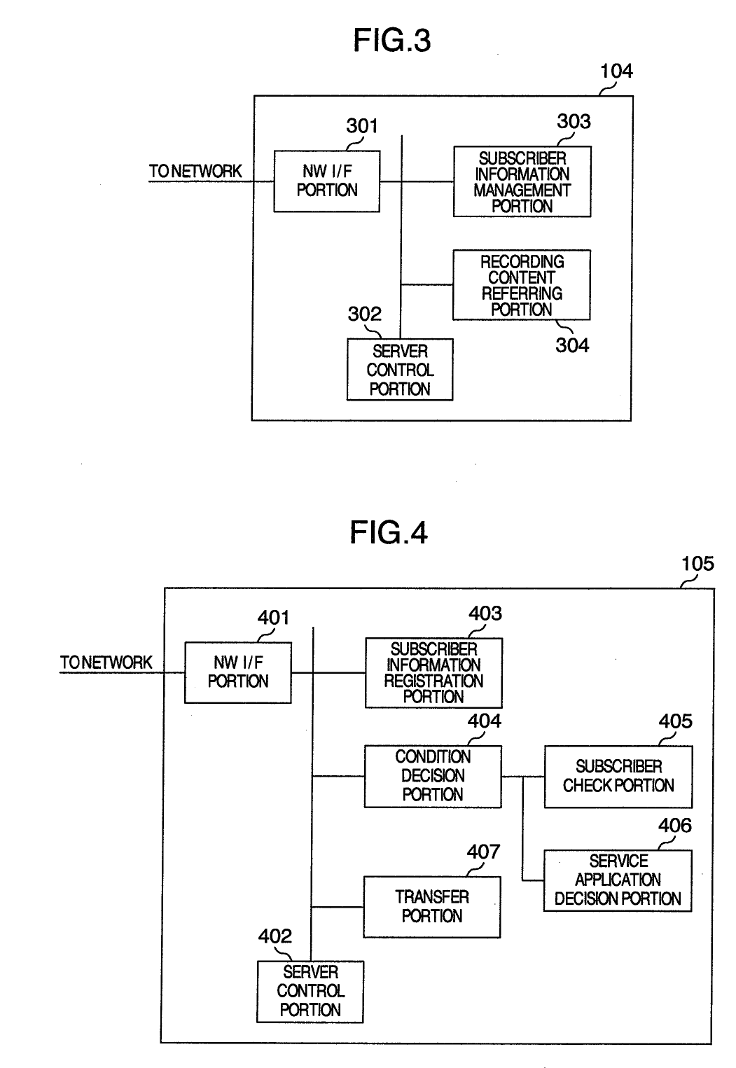

FIG. 3 shows the structure of the server having the handle server functions which act as a user interface when the subscriber receives the services of the present invention. The handle server functions offer environments in which the subscriber registers or updates service settings. When the subscriber replays and listens to the contents of the recorded phone conversations, the handle server functions act as a port. Additionally, the handle server functions preserve and manage the contents of the settings for each individual subscriber. When there is an addition or alteration to the settings, the handle server functions transfer the update information to the SIP server functions and to the phone conversation recording server functions.

The handle server functions are composed of functions realized by existing techniques and functions associated with the present invention. The former functions realized by the existing techniques are implemented by a network interface (NW I/F) portion 301 and a server control portion 302. The network interface portion 301 performs communications with other servers. The server control portion 302 controls the whole process of the server. The functions associated with the invention are implemented by a subscriber information management portion 303 and a recording content referring portion 304. The subscriber information management portion 303 manages information about the settings of the service subscribers and acts as a user interface. In addition, the management portion 303 expands the registered and updated setting information into the SIP server 105 and into the phone conversation recording server 107.

The recording content referring portion 304 functions as a user interface in a case where a service subscriber replays and listens to the recorded phone conversations. The referring portion 304 asks the recording server 107 to route the information about the conversation to be replayed and receives the information. Then, the referring portion plays back the contents of the conversation.

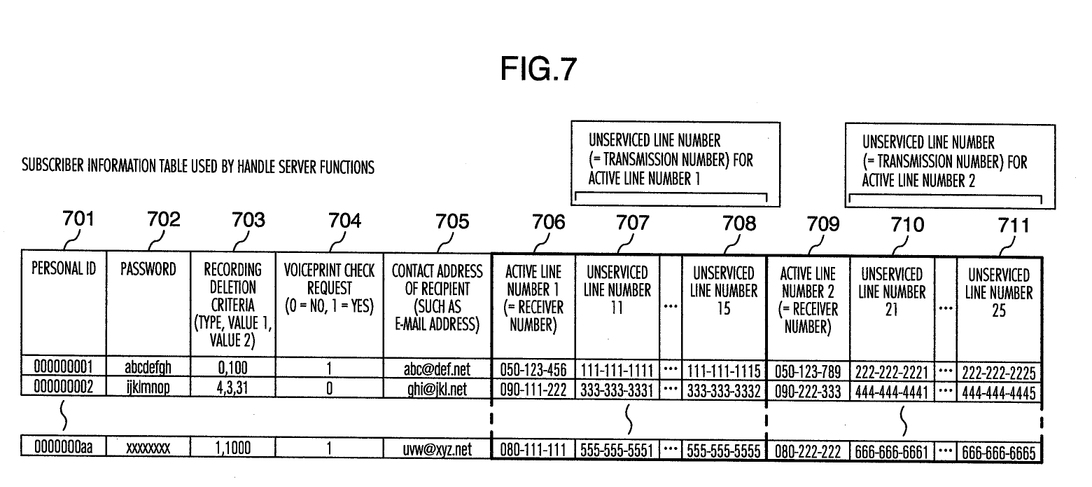

FIG. 7 shows a subscriber information table used by the server having the handle server functions. The subscriber information table holds information necessary to sort phone conversations to which the services of the present invention are applied and information about the destination when a warning is produced. Besides, the details of the contents of the services for each subscriber such as settings of criteria by which recordings of the contents of phone conversations are deleted are recorded. The handle server functions act to keep the subscriber information table used by the other server functions up to date.

The subscriber information table used by the handle server functions is a master table for the subscriber information table used for the other server functions. The other server functions simply refer to a table holding a copy of the contents of the master table and do not add, erase, alter, or otherwise process information. In terms of certain server functions, the information held in the subscriber information table is not different in meaning from the information held in the master table.

Where plural server functions including the handle server functions are realized on a single physical server, it is not necessary to create a subscriber information table for each individual server function. Since each server function refers to the subscriber information table managed by the handle server functions, transfer of update information between servers via the network is dispensed with.

Therefore, in both subscriber information table used by each server function and subscriber information table of the handle server functions (i.e., the master table), identical reference numerals are used to indicate identical components of each table.

The components of the subscriber information table of FIG. 7 are now described. A personal ID 701 is an identification number uniquely assigned to each subscriber. A single ID is given to each one subscriber. However, to permit a single subscriber to have plural phone lines, plural telephone numbers can be linked to a single ID. When a subscriber replays and listens to the contents of recorded phone conversations, a search is done using his personal ID 701 as the main key.

A password 702 giving information for identifying the subscriber himself is used together with a personal ID when a subscriber checks or modifies the contents of the subscriber information table, for example, via a website. Recording deletion criteria 703 hold the types of deletion criteria and the settings of quantitative data that supplement the contents of the criteria to permit old recordings under certain conditions to be deleted.

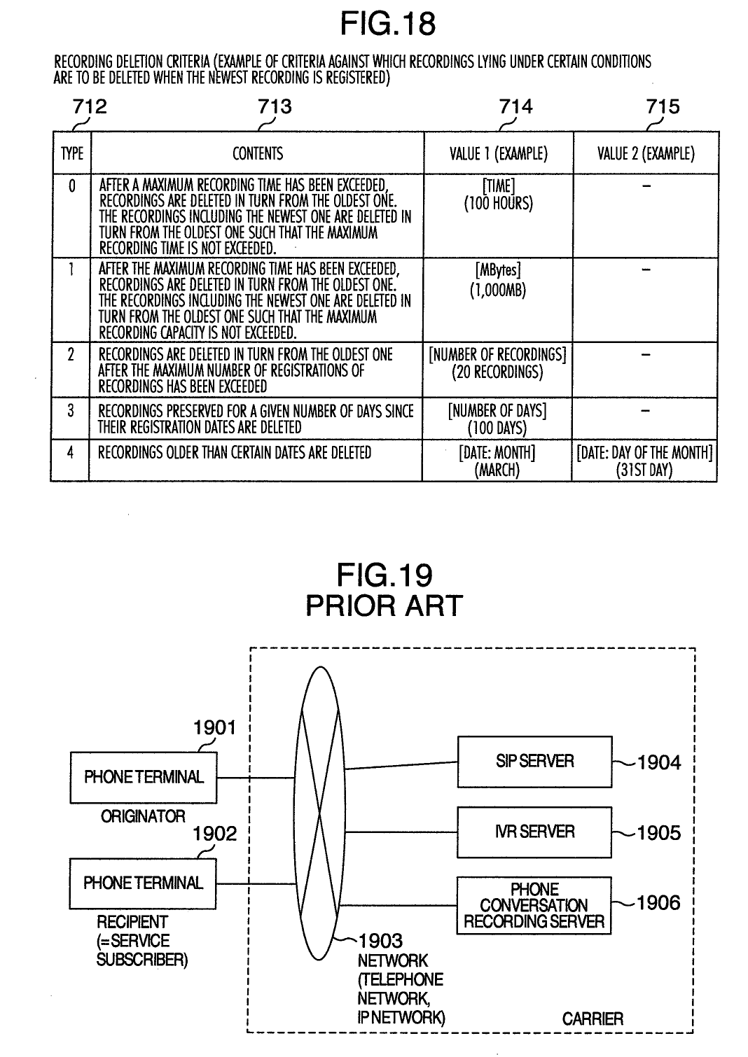

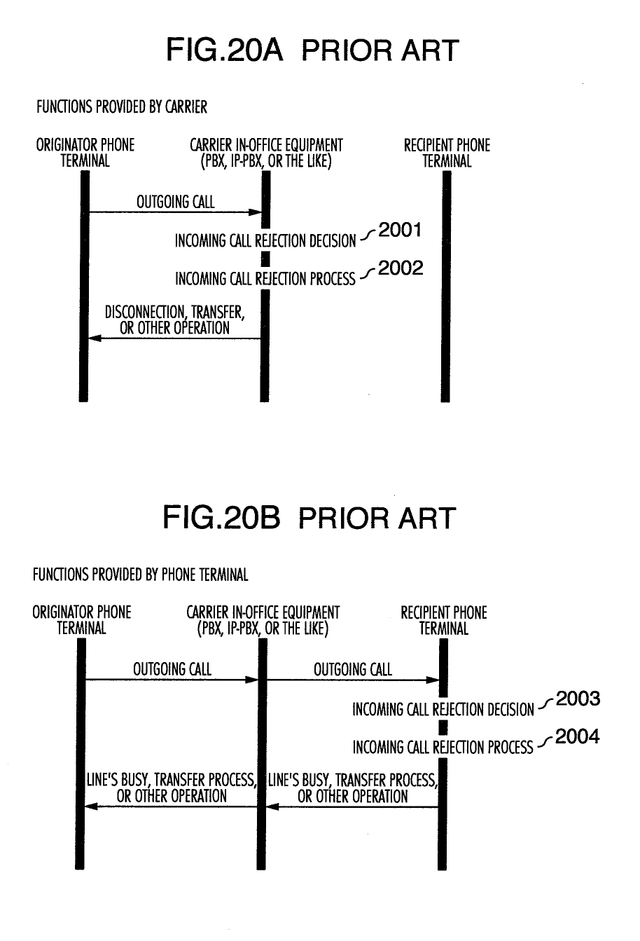

One example of content of the recording deletion criteria 703 is shown in FIG. 18. The reason why plural deletion criteria are provided is to prevent a malicious person from finding out the period of the recording deletion. Type 712 in FIG. 18 is a value derived from conditions under which a deletion decision is made (items 713) to facilitate processing of the conditions on the server. Values 714 and 715 of FIG. 18 are parameters complementarily used to quantitatively define the conditions under which the deletion decision is made. The type 712 and the values 714 and 715 are converted into numerical values and set into the recording deletion criteria 703.

For example, where type 712=0, value 714=0, and value 715=no value (or 0) are set into the recording deletion criteria 703 as shown in FIG. 18, phone conversation recordings are deleted in turn from the oldest one when the total time of phone conversation recordings of the subscriber has exceeded 100 hours, until the total time including the newest recording of phone conversation becomes less than 100 hours.

A voiceprint check request 704 makes a decision for each subscriber as to whether or not a voiceprint check is done after a recording of a phone conversation. The contact address 705 of a recipient holds the contact address (such as an e-mail address) of the subscriber when a warning has been issued. The following is information linked to each telephone line for the subscribers. In the illustrated example, one subscriber can subscribe to up to two telephone lines. Active line numbers 706 and 709 set telephone numbers of subscribers to which the services of the present invention are applied.

Recording-unserviced line numbers 707, 708, 710, and 711 means that if the telephone number of the destination of the call is coincident with any one of the active phone line numbers but the telephone number of the originator is coincident with any one of these unserviced line numbers, then the services of the present invention are not applied. When the subscriber does not want to record the contents of the phone conversation with a certain originator, information indicating this is set.

The configuration of the server having the SIP server functions is shown in FIG. 4. The SIP server functions make a decision as to whether the services of the present invention are applied or normal telephonic services are continued when an incoming call to a subscriber occurs from an unspecified originator. The SIP server functions are composed of the functions realized by the existing techniques and functions associated with the present invention.

The functions realized by the existing techniques are implemented by a network interface portion 401 and a server control portion 402. The network interface portion 401 performs communications with other server. The server control portion 402 controls the whole process of the SIP server. The functions associated with the present invention are implemented by a subscriber information registration portion 403, a condition decision portion 404, a subscriber check portion 405, a service application decision portion 406, and a transfer portion 407. The subscriber information registration portion 403 causes the subscriber information expanded from the handle server 104 to be registered or updated into the database in the SIP server.

When there is an incoming call from an originator, the condition decision portion 404 routes the call to the IVR server 106 and makes a decision as to whether the services are applied or the normal telephonic services are continued. The condition decision portion 404 has the subscriber check portion 405 and the service application decision portion 406 to confirm the conditions in further detail.

The subscriber check portion 405 makes a decision as to whether the telephone number of the destination matches any one of the telephone numbers of the service subscribers registered in the subscriber information. If the subscriber check portion 405 has determined that the destination has a subscriber's telephone number, the service application decision portion 406 makes a decision as to whether the telephone number of the originator is set as a telephone number which is registered in the subscriber information and to which phone conversation recording is not applied.

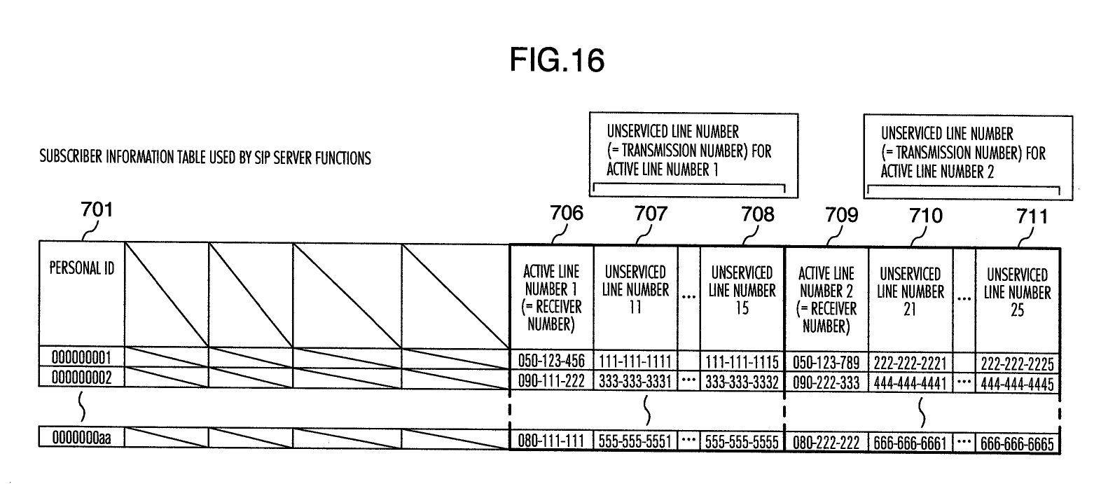

If the condition decision portion 404 has determined that the application of the services is carried out, the transfer portion 407 routes call control to the IVR server 106. FIG. 16 shows a subscriber information table used by the server having the SIP server functions. The SIP server functions make a decision as to whether or not the services of the present invention are applied, using the telephone number of the destination of the call, the telephone number of the originator, and the subscriber information table.

This subscriber information table is identical in configuration, content, and meaning to the subscriber information table in the handle server. Pieces of information not used by the SIP server functions are indicated by diagonal lines. A check is made if the telephone number of the destination of the call is present in the active line number 706 or 709 in the subscriber information table. Furthermore, if it is confirmed that the number of the originator does not exist in the unserviced line numbers 707, 708, 710, or 711, then the services of the present invention are applied.

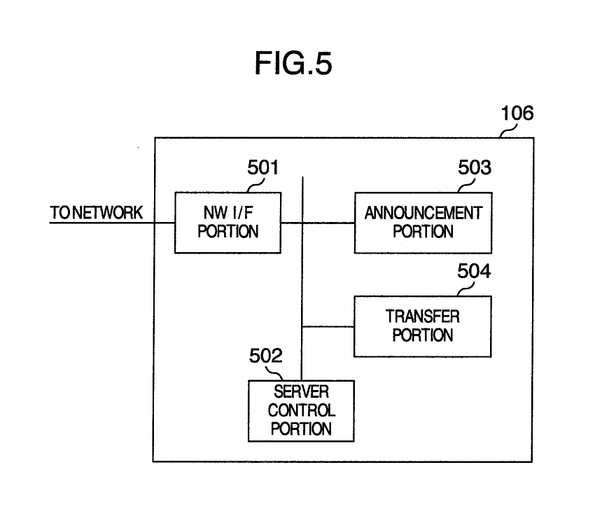

The configuration of the server having the IVR server functions is shown in FIG. 5. The IVR server functions once receive the call routed from the SIP server 105 and issue a voice announcement to the originator to the effect that the contents of the telephonic conversation will be recorded. Then, the IVR server functions route the call to the phone conversation recording server 107. The IVR server is composed of functions realized by the existing techniques and functions associated with the present invention. The functions realized by the existing techniques are implemented by a network interface portion 501 and a server control portion 502. The network interface portion 501 performs communications with other server. The server control portion 502 controls the whole process of the IVR server. The functions associated with the present invention are implemented by an announcement portion 503 and a transfer portion 504.

The announcement portion 503 receives the call routed from the SIP server 105, once causes the IVR server 106 to accept the call from the sender, and issues a voice announcement to the sender to the effect that recording will be started after the acceptance of the call by the recipient and the conversation recording will be stored. More specifically, a prerecorded voice announcement is played back and sent into the phone terminal 101 of the sender. Then, call control is transferred to the next transfer portion 504. The transfer portion 504 routes the call to the phone conversation recording server 107. The IVR server functions use no data table.

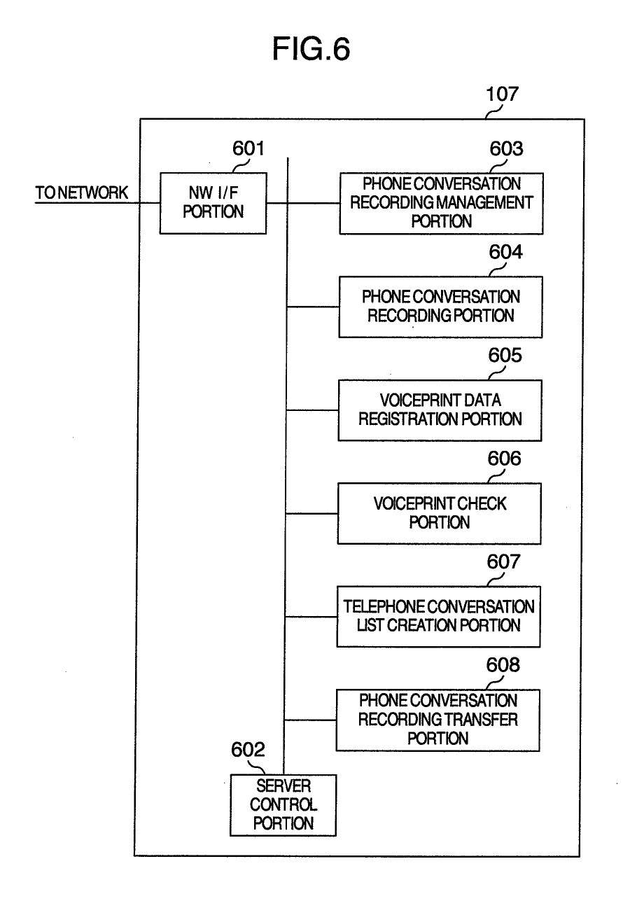

FIG. 6 shows the configuration of the server having the phone conversation recording server functions. The phone conversation recording server functions establish the call received from the IVR server 106 (i.e., prompt the recipient to accept the call), maintain the connection until the call is disconnected, and record the contents of the conversation. After the disconnection of the call, the recorded speech information is registered and stored in the database of the server itself. Voiceprint data about the originator is extracted and compared with the voiceprint data about the registered persons under surveillance.

When a hit is obtained or the rate of coincidence is higher than a given value, a warning is issued to the system administrator and to the recipient. The phone conversation recording server is composed of functions realized by the existing techniques and functions associated with the present invention. The functions realized by the existing techniques are implemented by a network interface portion 601 and a server control portion 602. The network interface portion 601 performs communications with other server.

The server control portion 602 controls the whole process of the phone conversation recording server. The functions associated with the present invention are implemented by a phone conversation recording management portion 603, a phone conversation recording portion 604, a voiceprint data registration portion 605, a voiceprint check portion 606, a phone conversation list creating portion 607, and a phone conversation recording transfer portion 608. The phone conversation recording management portion 603 records the recorded speech data and ancillary information and performs various kinds of processing on the speech recording table (such as information addition, saving, search, and erasure). The present functions provide control of the functions of the phone conversation recording server, give instructions about operation of various functions activated along the flow of processing, and transmit and receive information.

The phone conversation recording portion 604 stores data about speech during a phone conversation into the server. After the end of the conversation, the recording portion 604 passes information to be registered to the phone conversation recording management portion 603. In the present example where a network is assumed, speech uttered by the sender toward the recipient and speech uttered by the recipient toward the sender are each taken as an independent speech and recorded. Therefore, two speech data sets are created for one session of telephone conversation.

The voiceprint data registration portion 605 performs various kinds of processing (such as addition, saving, search, and deletion) on the registered voiceprint table in which voiceprint data obtained in the past from fraudsters and criminals are stored. The addition and deletion of voiceprint data are not allowed to be done at will by service subscribers from a viewpoint of protection of personal information. Rather, these operations are done only on the authority of the server administrator or service administrator. Addition or deletion of information to or from the registered voiceprint table may be done at any time. The processing for the addition or deletion is a simple operation for adding or deleting a record to or from the database and so a flowchart and a description of a sequence of operations for such processing are omitted herein.

The voiceprint check portion 606 extracts voiceprint information from the sender speech data registered in the recording table, compares the extracted voiceprint information against the voiceprint information in the registered voiceprint table, and makes a decision as to whether there is a hit. If the result of the decision is that there is a hit or the rate of coincidence is higher than a given value, a warning is issued to the contact address of the recipient and to the service administrator, together with the result of the decision.

When a service subscriber refers to the recordings of phone conversations via the handle server 104, the phone conversation list creating portion 607 creates a list of records in the recorded speech table, where the service subscriber is registered as a recipient, and sends the list back to the handle server 104. The contents of the list of the phone conversations sent back do not contain speech data, taking account of the influence on the communication band.

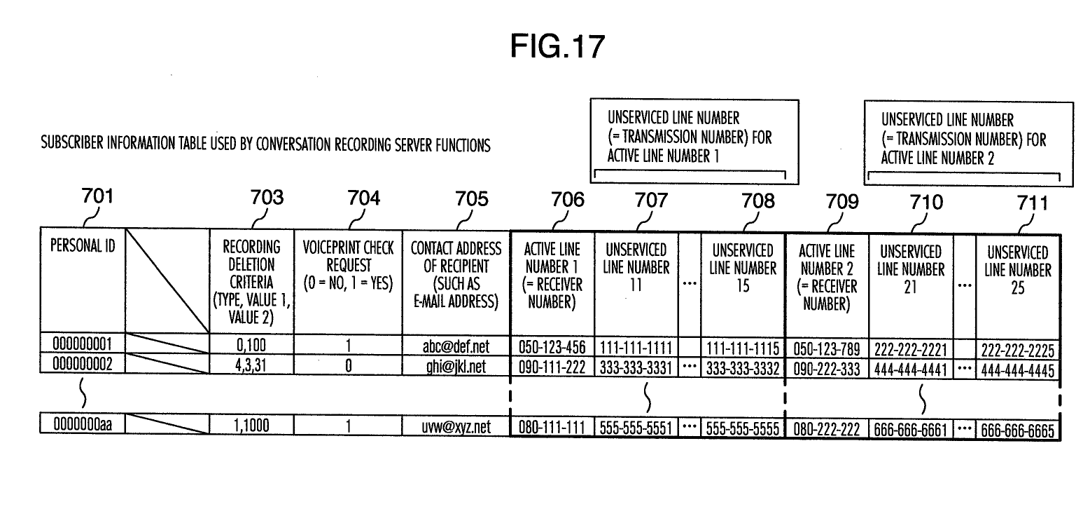

When a service subscriber has made a request for playback of a phone conversation that he wants to hear via the handle server 104, the phone conversation recording transfer portion 608 routes the corresponding sender speech data and recipient speech data to the handle server 104. FIG. 17 shows a subscriber information table used by the server having the phone conversation recording server functions. The conversation recording server functions use the subscriber information table in storing post-recording phone conversation data and ancillary information, making a decision as to whether voiceprint is checked, or deriving information about the contact address upon issuance of a warning.

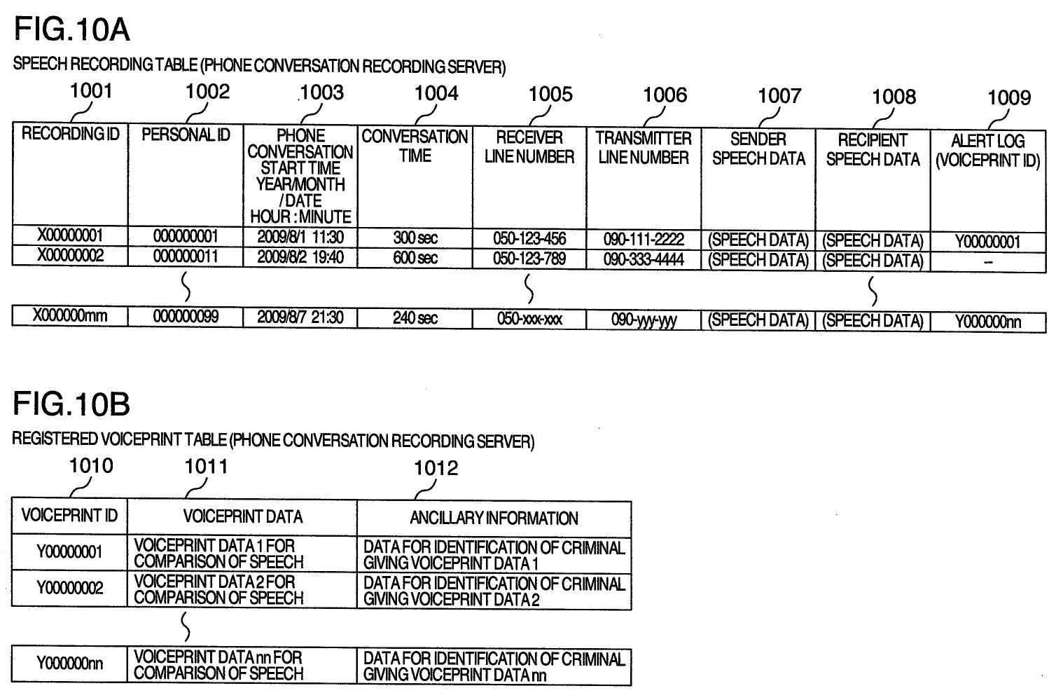

The subscriber information table of FIG. 17 is identical in configuration, content, and meaning to the subscriber information table in the handle server. The pieces of information not used by the phone conversation recording server functions are indicated by diagonal lines. FIGS. 10A and 10B show a speech recording table and a registered voiceprint table, respectively, used by the phone conversation recording server 107. The speech recording table stores the recordings of phone conversations made by the phone conversation recording server, together with ancillary information such as date. When a subscriber makes a request for confirmation or playback, information about the corresponding phone conversation is offered to the handle server.

The registration voiceprint table holds samples of voiceprints extracted from the speeches of past fraudsters and criminals. Voiceprints extracted from post-recording speech data about the sender are compared against the samples of voiceprint held in the registered voiceprint table and a confirmation is made as to whether a hit is obtained.

The components of the phone conversation recording table of FIG. 10A are next described. A recording ID 1001 is a number automatically assigned uniquely from the server for each recording of a session of phone conversation, and is used for identification of the recording of each individual phone conversation. A recipient of interest has the personal ID 701 in the subscriber information table. The value of the personal ID 701 is put in a cell of a personal ID 1002, and is used to extract the recording of the corresponding subscriber when the recording of the phone conversation is replayed and listened to. Cells of phone conversation start time 1003 and conversation time 1004 hold the date and time at which a recording of a phone conversation was made and the conversation time. A cell of receiver line number 1005 holds the telephone number of the subscriber whose incoming call has been accepted.

A cell of a transmitter line number 1006 holds the telephone number of the originator. Cells of sender speech data 1007 and recipient speech data 1008 hold a reproducible audio data set in which two speeches (respectively uttered by the sender and recipient) within one session of telephone conversation are separately recorded. If voiceprint data 1011 held in the registered voiceprint table contains a data set that can be judged to match any voiceprint extracted from the sender speech data 1007, then the value of a voiceprint ID 1010 of that voiceprint data is recorded in a cell of alert log 1009.

The components of the registered voiceprint table of FIG. 10B are next described. The voiceprint ID 1010 is a uniquely assigned number and acts as a main key in the registered voiceprint table. The voiceprint data 1011 is used for comparison with the voiceprint extracted from the recording of the phone conversation of the originator. Cells of ancillary information 1012 hold samples of voiceprints extracted from the speeches of past fraudsters and criminals. That is, the cells of ancillary information 1012 hold information necessary to identify the fraudster or criminal corresponding to the voiceprint data 1011.

The services of the present invention consist of three independent routines: subscriber information registration routine, phone conversation recording routine, and recording playback routine. The contents of the routines are described below.

The subscriber information registration routine is used to cause information necessary before the service subscriber accepts the services to be registered in the carrier. A service subscriber logs in the handle server 104 and registers necessary information. The registered contents are reflected in the cells 701-711 of the subscriber information table of FIG. 7. After establishment of the contents of the registration, the handle server 104 expands the necessary information into the SIP server 105 and into the phone conversation recording server 107.

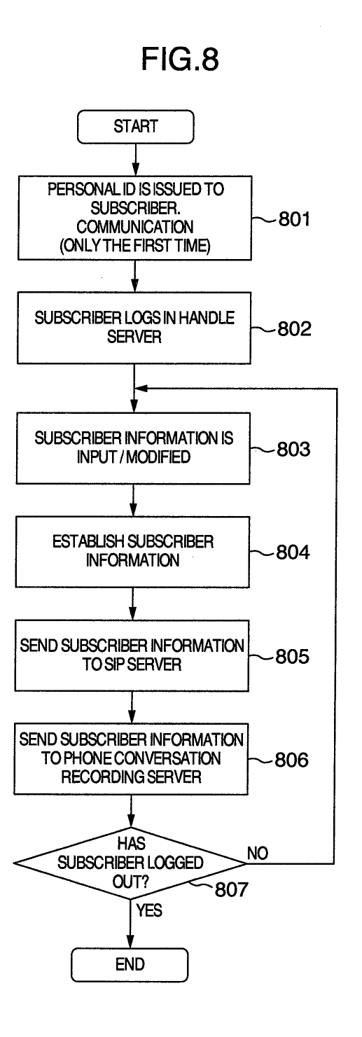

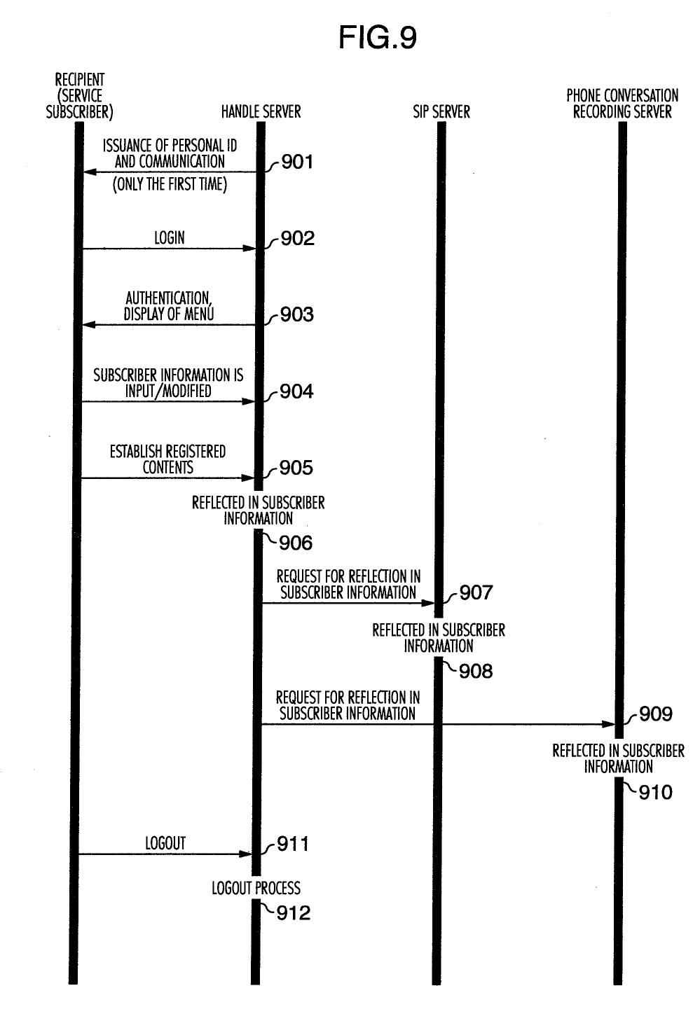

FIG. 8 illustrates a flowchart for executing the subscriber information registration routine, the flowchart including steps 801-807. FIG. 9 illustrates a sequence of operations (steps) 901-912 of the subscriber information registration routine. In the following description of the processing illustrated in FIGS. 8 and 9, it is assumed that a service subscriber uses the phone terminal 102 in performing communications with the handle server 104.

The flow of processing is described with reference to the flowchart of FIG. 8. First, at step 801 of FIG. 8, the handle server 104 communicates information (personal ID 701 and password 702) enabling settings necessary for a service subscriber to receive the services of the present invention. In particular, the following processing is performed.

The subscriber information management portion 303 included in the handle server 104 adds a new record to the subscriber information table within the server. The management portion 303 registers the values of the personal ID 701, password 702, line number 706 used by the service subscriber, and active line number 709 (in a case where plural lines are used) into the newly added record. The other values are set to values arbitrarily set by the carrier or to null values (i.e., the cells are empty and have no values).

The subscriber information management portion 303 communicates the personal ID 701 and password 702 to the service subscriber via e-mail or other means. The processing performed thus far is the operation 901 of FIG. 9. The steps 801 and 901 are performed only once before the service subscriber receives the services and first logs in the handle server 104. In a case where the service subscriber already performed the subscriber information registration routine once, the steps 801 and 901 are omitted.

At steps 801 and 901, the handle server 104 does not expand information contained in new records in the subscriber information table into the SIP server 105 or into the phone conversation recording server 107. The expansion of the information is carried out when the service subscriber updates the subscriber information and furthermore the request is reflected in the following processing.

Then, at step 802 of FIG. 8, the service subscriber logs in the handle server 104. The subscriber information management portion 303 in the handle server 104 confirms that the combination of the entered personal ID and password matches one of the combinations in the records within the subscriber information table (FIG. 7) in the server. If the confirmation is done successfully, a message indicating completion of authentication and a menu prompting registration and update of the set information are sent back to the service subscriber. This process corresponds to steps 902 and 903 of FIG. 9.

Then, at step 803 of FIG. 8, the service subscriber updates the contents of the corresponding record in the subscriber information table (FIG. 7) within the server through the menu presented from the handle server 104. The subscriber information management portion 303 in the handle server 104 receives the information in the record required to be updated by the service subscriber through the menu, and enters updating information and contents into the record of the subscriber information table of the server shown in FIG. 7. Information that can be updated by the service subscriber includes password 702, recording deletion criteria 703, voiceprint check request 704, contact address 705 of the recipient, and unserviced line numbers 707, 708, 710, and 711 for each active line number. This updating operation corresponds to step 904 of FIG. 9.

Then, at step 804 of FIG. 8, the service subscriber asks the handle server 104 to establish the information in the updated record (i.e., to update the record in the subscriber information table). This corresponds to step 905 of FIG. 9. In response to the request from the service subscriber, the subscriber information management portion 303 in the handle server 104 updates and establishes the information in the corresponding record within the subscriber information table shown in FIG. 7. This corresponds to step 906 of FIG. 9.

Then, at step 805 of FIG. 8, the handle server 104 expands the contents of update of the subscriber information table into the SIP server 105. Where the handle server 104 and SIP server 105 coexist as virtual servers on the same physical server, the subscriber information table to which the two servers make reference is the common table within the same physical server and so the SIP server 105 does not perform the following routine for updating the subscriber information table. Control goes to the next processing without performing step 805.

Where the handle server 104 expands the update information into the SIP server 105, the subscriber information management portion 303 in the handle server 104 sends the update information about the subscriber information table to the subscriber information registration portion 403 of the SIP server 105. This corresponds to step 907 of FIG. 9.

In response to the update information, the subscriber information registration portion 403 of the SIP server 105 updates the information in the subscriber information table within the server. This corresponds to step 908 of FIG. 9.

Then, at step 806 of FIG. 8, the handle server 104 expands the contents of the updated subscriber information table into the phone conversation recording server 107. Where the handle server 104 and phone conversation recording server 107 coexist as virtual servers on the same physical server, the subscriber information table to which the two servers make reference is the common table within the same physical server and so the conversation recording server 107 does not perform the following routine for updating the subscriber information table. Control goes to the next processing without performing step 806.

Where the SIP server 105 and the phone conversation recording server 107 coexist as virtual servers on the same physical server, the subscriber information table to which the two servers make reference is the common table within the same physical server and so the recording server 107 performs the following routine for updating the subscriber information table only for information 703, 704, and 705 necessary for the phone conversation recording routine.

Where the handle server 104 expands the update information into the phone conversation recording server 107, the subscriber information management portion 303 of the handle server 104 sends update information about the subscriber information table to the phone conversation recording management portion 603 of the phone conversation recording server 107. This corresponds to step 909 of FIG. 9.

In response to the update information, the phone conversation recording management portion 603 of the phone conversation recording server 107 updates the information in the subscriber information table within the server. This corresponds to step 910 of FIG. 9.

Then, at step 807 of FIG. 8, the service subscriber terminates the update menu about the subscriber information, the menu being provided from the handle server 104, and makes a check as to whether the subscriber logs out. If the subscriber logs out, the subscriber information management portion 303 in the handle server 104 terminates the subscriber information registration routine. This corresponds to step 911 of FIG. 9.

The subscriber information management portion 303 in the handle server 104 performs step 912 of FIG. 9 to carry out a logout operation by leaving behind information occurring before and after the update in the log. If the subscriber does not log out, the subscriber information management portion 303 in the handle server 104 determines that the subscriber information table updating routine is continued, and control returns to step 803. In the phone conversation recording routine, if there is an incoming call to the service subscriber, a decision is made based on conditions and settings as to whether the services of the present invention are applied. If the decision is that the services should be applied, a voice announcement indicating that the phone conversation will be recorded is issued to the recipient. The conversation is recorded. The recording is registered in the recording table. A voiceprint check is performed.

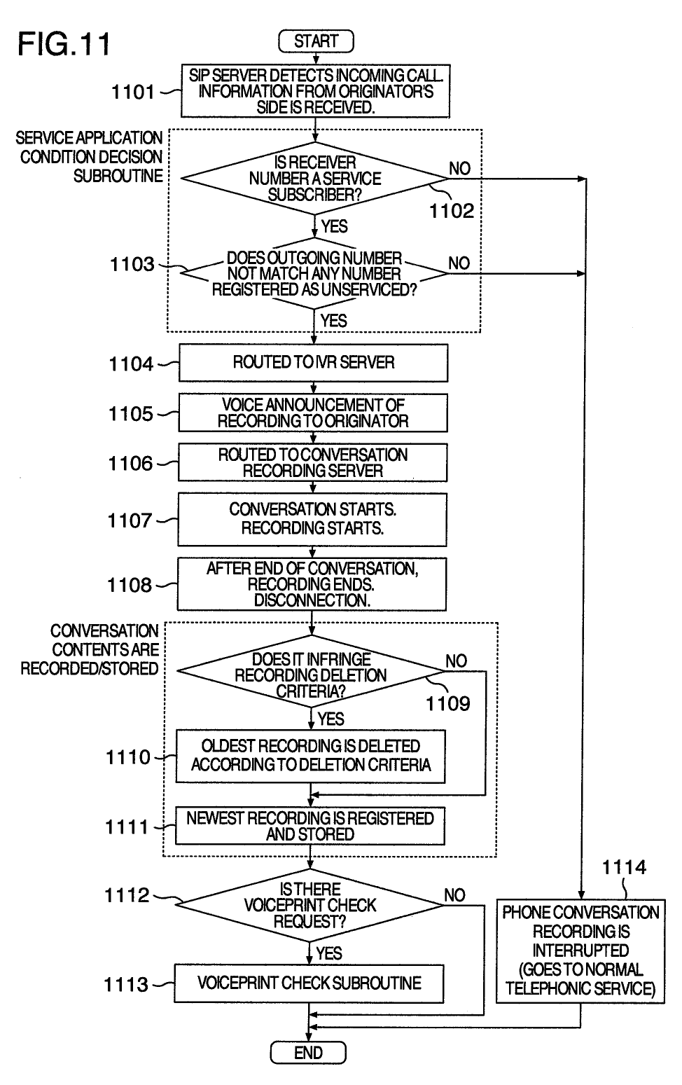

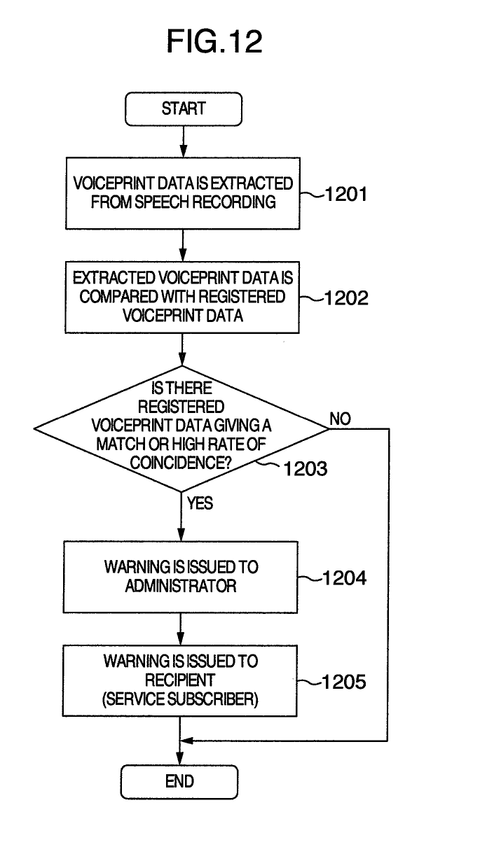

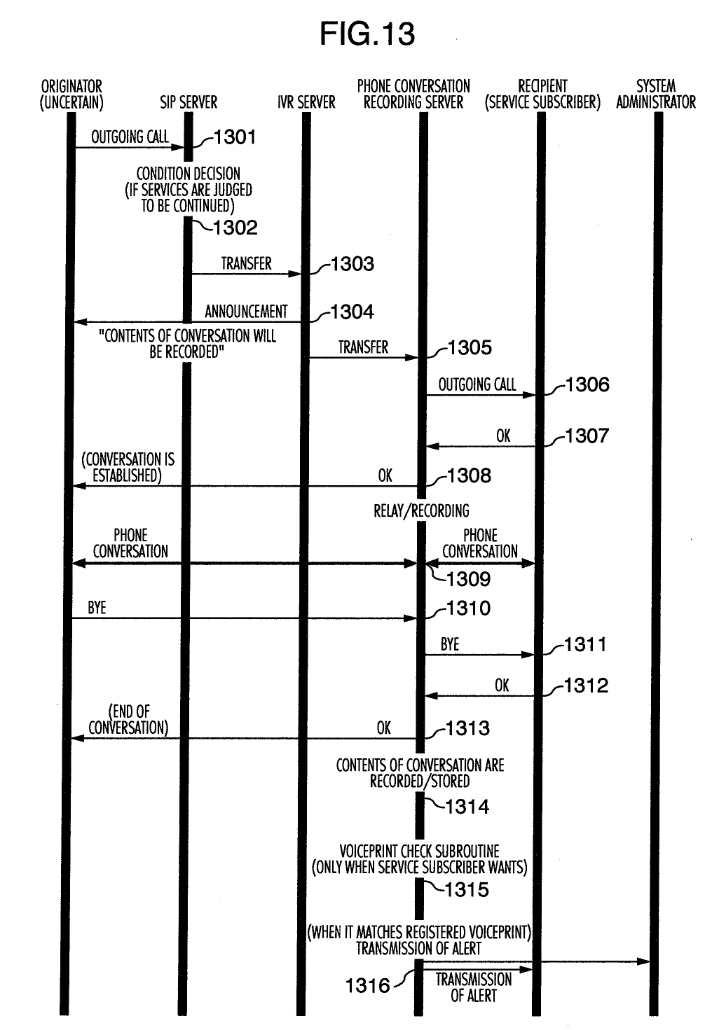

FIG. 11 illustrates a flowchart depicting the phone conversation recording routine, the flowchart including steps 1101-1114. FIG. 12 illustrates a flowchart depicting a Voiceprint Check subroutine including steps 1201-1202. The Voiceprint Check subroutine is a part of the phone conversation recording routine. Step 1113 of FIG. 11 corresponds to steps 1201-1205 of FIG. 12. FIG. 13 illustrates a sequence of operations 1301-1316 of the phone conversation recording routine. In the following description, it is assumed that the originator and recipient use the phone terminals 101 and 102, respectively.

The flow of processing is described by referring to the flowcharts of FIGS. 11 and 12. First, at step 1101 of FIG. 11, if an originator attempts to make a telephone call to a recipient, an incoming call occurs. The SIP server 105 detects the call from the originator. This detection is the function intrinsic to the SIP server 105. This corresponds to the operation 1301 of FIG. 13.

The next processing consists of steps 1102 and 1103 of FIG. 11. A decision is made as to whether the services of the present invention should be applied in response to the generated call. For this purpose, the condition decision portion 404 in the SIP server 105 compares the information about the call (i.e., the telephone number of the recipient and the telephone number of the originator) with the information contained in the subscriber information table within the server.

The condition decision portion 404 in the SIP server 105 has a function of performing two checks. One is implemented by the subscriber check portion 405 that makes a decision as to whether the telephone number of the destination is a telephone number registered by a service subscriber. The other is implemented by the service application decision portion 406 that makes a decision as to whether the telephone number of the originator matches any one of the unserviced telephone numbers which is set by the service subscriber and to which the services of the invention are not applied.

Then, at step 1102 of FIG. 11, the SIP server 105 makes a decision as to whether the telephone number of the destination matches the telephone number of any one of the service subscribers. The subscriber check portion 405 in the condition decision portion 404 of the SIP server 105 makes a check as to whether the telephone number of the destination is coincident with information 706 about the active line number 1 or information 709 about the active line number 2 in the subscriber information table in the server. If there is a coincident record, control proceeds to the next step 1103.

If no match is found, it is determined that the telephone number of the destination is not any one of the line numbers used by the service subscribers and that the services of the present invention are not applied. Control then proceeds to normal telephonic services. That is, control goes to step 1114 of FIG. 11.

Then, at step 1103 of FIG. 11, the SIP server 105 makes a check as to whether the services of the present invention should be applied to the telephone number of the originator. The service application decision portion 406 in the condition decision portion 404 of the SIP server 105 makes a check as to whether the telephone number of the originator matches any one of the line numbers 707, 708, 710, and 711 registered as unserviced numbers in the corresponding record of the subscriber information table within the server.

If there is a match, it follows that the telephone number of the originator is a number for which phone conversation recording is set to be unnecessary by the service subscriber. Therefore, it is determined that the services of the present invention are not applied to this telephone number. Control proceeds to normal telephonic services. That is, control goes to step 1114 of FIG. 11.

If no match is found, the telephone number of the originator is judged to be a telephone number to which the services of the invention are applied. Control proceeds to the next step 1104 of FIG. 11. Steps 1102 and 1103 of FIG. 11 correspond to the operation 1302 of FIG. 13.

Then, at step 1104 of FIG. 11, the SIP server 105 routes the call to the IVR server 106 in order to issue a voice announcement to the originator to the effect that the contents of the phone conversation will be recorded. The transfer portion 407 of the SIP server 105 passes call control to the announcement portion 503 of the IVR server 106. At this time, the transfer portion 407 of the SIP server 105 also passes the address information about the conversation recording server 107 to which the call is routed by the IVR server 106 after the execution of the voice announcement. This corresponds to the operation 1303 of FIG. 13.

Then, at step 1105 of FIG. 11, the IVR server 106 receives the call routed from the SIP server 105, once causes the IVR server 106 to accept the incoming call, and issues a prerecorded voice announcement to the originator to the effect that “The contents of the phone conversation will be recorded.”

The announcement portion 503 of the IVR server 106 receives the call routed from the transfer portion 407 of the SIP server 105 and once causes the announcement portion 503 of the IVR server 106 to accept the call. The call is established between the originator and the IVR server 106. The announcement portion issues the prerecorded voice announcement “The contents of the phone conversation will be recorded.” to the originator. Then, control proceeds to the next step. This corresponds to the operation 1304 of FIG. 13.

Then, at step 1106 of FIG. 11, the IVR server 106 routes the call to the phone conversation recording server 107. The transfer portion 504 of the IVR server 106 routes the call to the conversation recording portion 604 of the recording server 107, based on the address information about the recording server 107, the address information being passed from the transfer portion 407 of the SIP server 105. This corresponds to the operation 1305 of FIG. 13.

Then, at step 1107 of FIG. 11, the phone conversation recording server 107 receives the call from the IVR server 106, establishes the call with the service subscriber at the destination, and accumulates telephone conversations as speech data while interposed as a relay point for the telephone conversations. After receiving the call from the transfer portion 504 of the IVR server 106, the phone conversation recording portion 604 of the recording server 107 causes the recipient (i.e., a service subscriber) to accept the incoming call and establishes the call between the originator and the recipient. This corresponds to the operations 1306, 1307, and 1308 of FIG. 13.

After the call is established and a telephone conversation is started, the conversation recording portion 604 of the conversation recording server 107 accumulates the contents of the phone conversation as reproducible speech data while being located at the relay point for the phone conversation between the originator and the recipient. This corresponds to the operation 1309 of FIG. 13.

With respect to speech data, speeches are classified into two types of speech. One type of speech is uttered from the originator to the recipient (only the speech of the originator) and the other type is uttered from the recipient to the originator (only the speech of the recipient). The two types of speech are recorded separately. With the present technology, when a telephone conversation is made via a network, it is possible to record speech for each individual utterer. Furthermore, the conversational circumstances can be reproduced by playing back both types of speech at the same time.

In addition, during the Voiceprint Check subroutine (FIG. 12), when voiceprint of the originator is extracted from speech data, it is easy to judge whose voiceprint the speech data indicates in cases where a speech data set is available for each speech uttered. Where speech from the originator and speech from the recipient are mixed in speech data, the voiceprint of the recipient (i.e., a service subscriber) will also be extracted, and it will be necessary to discriminate it from the voiceprint of the originator. Where only speech from the originator exists, only the voiceprint of the originator is extracted.

At step 1108 of FIG. 11, if the phone conversation recording server 107 detects the end of a phone conversation, the server ends the recording of the conversation and disconnects the call. The phone conversation recording portion 604 of the recording server 107 detects the end of the conversation (e.g., the handset of the originator or recipient is put down or the disconnecting button is depressed), terminates the accumulation of speech data, and disconnects the call. These operations correspond to operations 1310, 1311, 1312, and 1313 of FIG. 13.

At steps 1109, 1110, and 1111 of FIG. 11, the phone conversation recording server 107 deletes the oldest one of the records of the service subscriber from the speech recording table of FIG. 10A in accordance with the recording deletion criteria selected by the subscriber and adjusts the number of records in the recording table. Then, the server adds a record including the new speech data.

At step 1109 of FIG. 11, the phone conversation recording portion 604 of the conversation recording server 107 searches the records of the pertinent service subscriber for any records infringing the recording deletion criteria 703 before new speech data is added to the recording table.

The search process is described in detail below. The phone conversation recording portion 604 of the conversation recording server 107 searches the subscriber information table in the server for the record containing the personal ID 1002 of the recording table which matches the personal ID 701 of the record in the speech recording table of the corresponding service subscriber.

Then, a decision is made as to whether the detected record of the recording table infringes the record deletion criteria 703 set by the service subscriber. In the operation 1110 of FIG. 11, if there are any records of the recording table that infringe the recording deletion criteria 703, the phone conversation recording portion 604 of the recording server 107 deletes the records in turn from the oldest one.

At step 1111 of FIG. 11, after the execution of step 1110 or when any record infringing the recording deletion criteria 703 does not exist in the speech recording table, the phone conversation recording portion 604 of the phone conversation recording server 107 adds a record containing new speech data to the recording table.

The following values are put in the record added to the speech recording table. The phone conversation recording portion 604 creates the recording ID 1001 such that this ID exists uniquely within the server. The personal ID 701 of the corresponding service subscriber is put in the cell of the personal ID 1002. The phone conversation start time 1003, conversation time 1004, receiver line number 1005, and transmitter line number 1006 are derived from the call information. With respect to the sender speech data 1007 and recipient speech data 1008, speech data obtained by steps 1107 and 1108 is registered. A null value is entered as a default value in the alert log 1009. Steps 1109, 1110, and 1111 of FIG. 11 correspond to the operation 1314 of FIG. 13.

Then, at step 1112 of FIG. 11, the phone conversation recording server 107 checks if the service subscriber has provided a setting to perform a voiceprint check. The voiceprint check portion 606 of the phone conversation recording server 107 checks the value of the voiceprint check request 704 in the record having a personal ID coincident with the personal ID 701 of the service subscriber, the record being in the subscriber information table in the server.

If the value of the voiceprint check request 704 has been checked, the next Voiceprint Check subroutine 1113 of FIG. 11 which is illustrated particularly in FIG. 12 is carried out. If the value of the voiceprint check request 704 has not been checked, the phone conversation recording routine is terminated without performing the Voiceprint Check subroutine.

If the result of the decision 1112 of FIG. 11 is that the Voiceprint Check subroutine is performed, the Voiceprint Check subroutine 1113 of FIG. 11 is carried out. The Voiceprint Check subroutine 1113 is particularly illustrated in the flowchart of FIG. 12. The Voiceprint Check subroutine corresponds to the operation 1315 of FIG. 13. The Voiceprint Check subroutine is next described in detail. The whole Voiceprint Check subroutine is performed by the voiceprint check portion 606 of the phone conversation recording server 107.

At step 1201 of FIG. 12, the speech recording table is searched for the record which has the personal ID 1002 coincident with the personal ID of the corresponding service subscriber and which has the newest conversation start time 1003. The voiceprint data about the originator is extracted from the sender speech data 1007 contained in the found record.

At step 1202 of FIG. 12, the voiceprint data extracted at step 1201 is compared against the voiceprint data 1011 contained in the registered voiceprint data, and a record of the registered voiceprint data having a matching probability in excess of a given value is searched for.

At step 1203 of FIG. 12, a decision is made as to whether the registered voiceprint data found by the searching contains any records satisfying the conditions. If there are any pertinent records, control goes to step 1204. If there are no pertinent records, it is determined that there is no match with the voiceprints of the past fraudsters and criminals. Consequently, the Voiceprint Check subroutine is terminated.

At step 1204 of FIG. 12, a notice is given via e-mail, pop-up window, or other means to the server administrator or system administrator to the effect that a phone conversation matching the voiceprint of any one past fraudster or criminal took place with a high probability, together with other information (i.e., the voiceprint ID 1010 in the registered voiceprint table, ancillary information 1012, and recording ID 1001 in the speech recording table).

At step 1205 of FIG. 12, a notice is given by e-mail or other means to the service subscriber to the effect that a phone conversation matching the voiceprint of any one past fraudster or criminal took place with a high probability, together with the information about the recording ID 1001 in the speech recording table. Then, the voiceprint ID 1010 of the voiceprint data set in the registered voiceprint table which gives the highest matching probability is recorded in the alert log 1009 of the speech recording table. After the end of step 1205, the Voiceprint Check subroutine is terminated. Steps 1204 and 1205 of FIG. 12 correspond to the operation 1316 of FIG. 13.

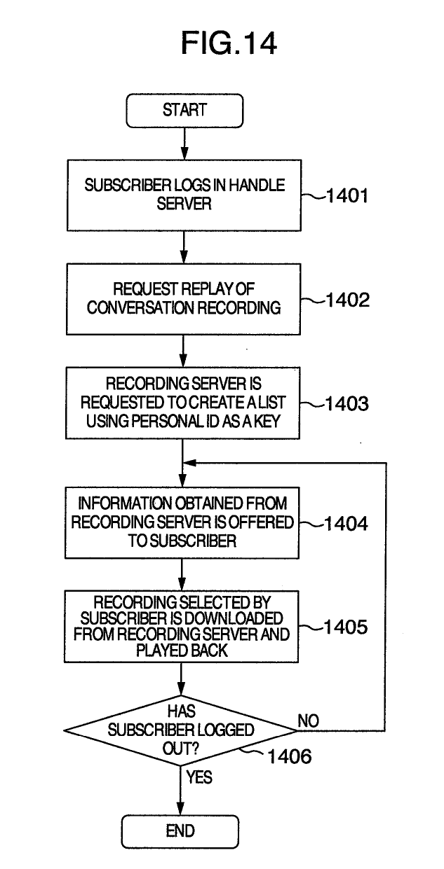

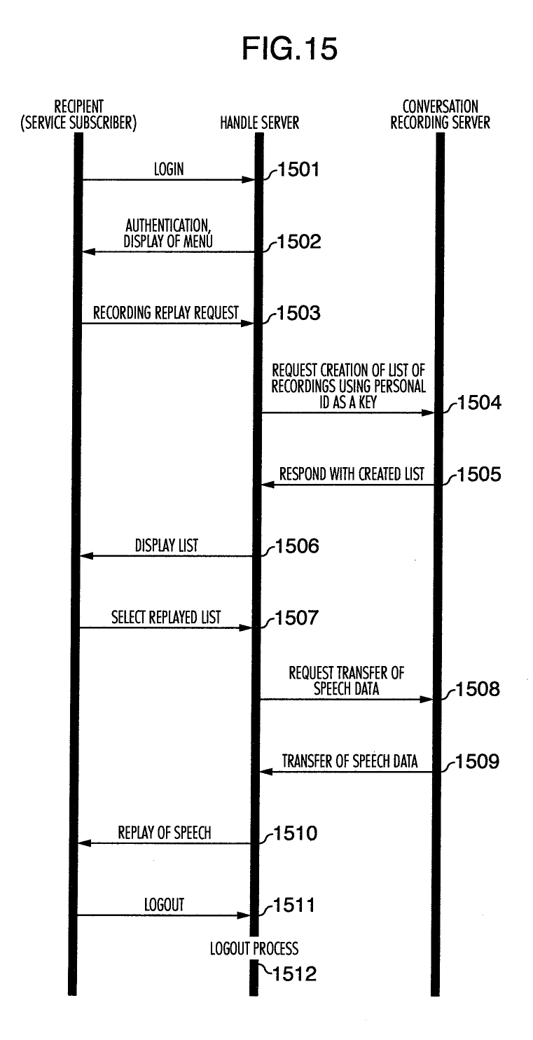

The recording playback routine is used to permit the service subscriber to replay and listen to speech recorded in the conversation recording server 107 at will. FIG. 14 illustrates a flowchart depicting the recording playback routine, the flowchart including steps 1401-1406. FIG. 15 illustrates operations 1501-1512 of the recording playback routine. The routine is now described according to the flowchart of FIG. 14. In the following processing, it is assumed that the service subscriber communicates with the handle server 104 using the phone terminal 101.

First, at step 1401 of FIG. 14, the service subscriber logs in the handle server 104. The subscriber information management portion 303 in the handle server 104 checks that any record in the subscriber information table within the server contains a combination matching the combination of the entered personal ID and password. If the check is done successfully, a message indicating completion of authentication and a menu prompting execution of the recording playback routine are sent back to the service subscriber. These steps correspond to operations 1501 and 1502 of FIG. 15.

Then, at step 1402 of FIG. 14, the service subscriber asks for playback of the speech recording through the menu provided from the handle server 104. The subscriber information management portion 303 in the handle server 104 transfers control to the recording content referring portion 304. This corresponds to the operation 1503 of FIG. 15.

Then, at step 1403 of FIG. 14, the handle server 104 asks the phone conversation recording server 107 to create a list of speech recordings of the service subscriber of interest. The recording content referring portion 304 in the handle server 104 asks the phone conversation list creation portion 607 of the recording server 107 to extract corresponding records from the speech recording table using the personal ID as a key and to create a list of the sender speech data 1007 and items of records other than the recipient speech data 1008. This process corresponds to the operation 1504 of FIG. 15.

In response to the request for creation of the list, the phone conversation creation portion 607 of the phone conversation recording server 107 extracts corresponding records from the speech recording table and sends back the list of the sender speech data 1007 and record items other than the recipient speech data 1008 to the recording content referring portion 304 in the handle server 104. This process corresponds to the operation 1505 of FIG. 15.

Because the sender speech data 1007 and recipient speech data 1008 are larger in data size than the other items, speech recordings are downloaded from the handle server 104 at step 1405 only when the service subscriber asks the speech to be played back. Then, the contents of the conversation are played back.

Then, at step 1404 of FIG. 14, the handle server 104 provides the list of recordings obtained at step 1403 to the service subscriber. The recording content referring portion 304 in the handle server 104 provides the contents of the recording list (items of information 1001, 1003, 1004, 1005, 1006, and 1009 indicating that the personal ID of the service subscriber matches one personal ID 1002 in the speech recording table) to the service subscriber. This step corresponds to the operation 1506 of FIG. 15.

Then, if the service subscriber has asked for replay of the contents of the phone conversations in the list at step 1405 of FIG. 14, the handle server 104 issues a request to the phone conversation recording server 107 to route the corresponding speech data. After completion of transfer of the speech data from the recording server 107 to the handle server 104, the contents of the conversations are played back.

The recording content referring portion 304 in the handle server 104 asks the phone conversation recording transfer portion 608 of the phone conversation recording server 107 to route the sender speech data 1007 and recipient speech data 1008 of the corresponding record while using the recording ID 1001 of the record for which replay of the conversation contents is required by the service subscriber. This step corresponds to the operations 1507 and 1508 of FIG. 15.

In response to the request for transfer of the speech data from the recording content referring portion 304 in the handle server 104, the phone conversation recording transfer portion 608 of the phone conversation recording server 107 forwards the sender speech data 1007 and recipient speech data 1008 in the record having the corresponding recording ID in the speech recording table to be routed. This step corresponds to the operation 1509 of FIG. 15.

The phone conversation recording transfer portion 608 of the phone conversation recording server 107 plays back the obtained sender speech data 1007 and recipient speech data 1008 simultaneously for the service subscriber, thus carrying out the replay of the contents of the phone conversation. This step corresponds to the operation 1510 of FIG. 15.

Then, at step 1406 of FIG. 14, a decision is made as to whether the service subscriber has terminated the update menu for the subscriber information provided from the handle server 104 and logs out. If the subscriber logs out, the recording content referring portion 304 in the handle server 104 performs a logout operation. That is, it deletes all of the list and speech data routed in from the recording server 107 out of the memory of the server. Thus, the recording playback routine is terminated. These steps correspond to the operations 1511 and 1512 of FIG. 15. If the subscriber does not log out, the recording content referring portion 304 in the handle server 104 determines that the recording playback routine is continued. Then, control returns to step 1404.

It should be further understood by those skilled in the art that although the foregoing description has been made on embodiments of the invention, the invention is not limited thereto and various changes and modification may be made without departing from the spirit of the invention and the scope of the appended claims.

1. A telephone conversation recording system for recording the contents of a telephone conversation conducted between terminals, the telephone conversation recording system comprising:
a call connection server for controlling a call connection between the terminals one of which acts as an originator terminal of an originator while the other acts as a receiver terminal;
a speech response server for sending a voice announcement to the originator terminal; and
a telephone conversation recording server for recording the contents of a telephone conversation conducted between the terminals;
wherein when a call connection request is received from the originator terminal, the call connection server routes the call connection request to the speech response server;
wherein the speech response server gives a notice to the originator terminal, which has issued the call connection request, to the effect that the contents of the telephone conversation will be recorded; and
wherein the telephone conversation recording server relays and records the contents of the telephone conversation when the telephone conversation is conducted between the originator terminal and the receiver terminal.

2. The telephone conversation recording system according to claim 1, wherein the call connection server has a subscriber information table for storing telephone numbers of subscribers and makes a decision as to whether an incoming call telephone number contained in the call connection request belongs to any one of the subscribers, and wherein if the incoming call telephone number belongs to any one of the subscribers, the call connection server routes the call connection request to the speech response server.

3. The telephone conversation recording system according to claim 2, wherein the subscriber information table further stores recording-unserviced telephone numbers not undergoing recording services in association with the telephone numbers of the subscribers, and wherein the call connection server refers to the subscriber information table and, if an outgoing telephone number matches any one of the recording-unserviced telephone numbers, makes a call connection between the originator terminal and the receiver terminal without via the speech response server or the speech recording server.

4. The telephone conversation recording system according to claim 3, wherein the subscriber information table further stores identifiers each for uniquely identifying each of the subscribers such that the telephone number or numbers of at least one of the subscribers and the recording-unserviced telephone numbers, each of which is set for each of the telephone numbers of the at least one of the subscribers, are associated with each other.

5. The telephone conversation recording system according to claim 1, wherein when the call connection request is received, the speech response server establishes a call with the originator terminal, gives a notice to the effect that the contents of the telephone conversation will be recorded, and then routes the call connection request to the telephone conversation recording server.

6. The telephone conversation recording system according to claim 1, wherein the speech recording server records originator's speech and recipient's speech separately.

7. The telephone conversation recording system according to claim 1,
wherein the telephone conversation recording server has a voiceprint table in which voiceprint data is registered, and
wherein the telephone conversation server refers to the voiceprint table, searches it for a registered voiceprint matching the voiceprint of recorded speech of the originator, and, if there is a match, gives a notice to a recipient to that effect.

8. The telephone conversation recording system according to claim 7, wherein when the registered voiceprints contain a voice print matching the voiceprint of speech of the originator, the telephone conversation recording server records an identifier uniquely identifying the matching registered voiceprint and the recorded originator's speech in association with each other.

9. The telephone conversation recording system according to claim 4, wherein there is further provided a management server for accepting a setting registration request from a subscriber, and wherein, when a setting registration request concerning any one of the recording-unserviced telephone numbers, each set for the telephone number of each subscriber, is received from the subscriber, the management server reflects the received registration request in the subscriber information table.

10. The telephone conversation recording system according to claim 9, wherein, when login information is received from a terminal of a subscriber, the management server returns a Recording Replay menu to the terminal of the subscriber that has sent the login information and, when a recorded speech replay request is received from the terminal of the subscriber via the menu, the management server returns the requested recorded speech.

11. The telephone conversation recording system according to claim 10, wherein the management server further sends a list of recorded speeches displayed by the menu to the terminal of the subscriber, and wherein the management server receives the recorded speech replay request using the list displayed on the menu from the terminal of the subscriber and then returns the recorded speech.
